(19) United States
(12) Patent Application Publication
(10) Pub. No.: US 2005/0062247 A1
(43) Pub. Date: Mar. 24, 2005

(54) 'Helping -cart' for assisting store customers

(76) Inventor: Sang K. Sheem, Pleasanton, CA (US)

Correspondence Address: SANG K. SHEEM, 1790 PASEO DEL CAJON, PLEASANTON, CA, 94566, US

(21) Appl. No.: 10/665,695

(22) Filed: Sep. 19, 2003

(51) Int. Cl. B62B 1/00

(52) U.S. Cl. 280/79.2

(57) ABSTRACT

A novel ‘helping-cart’ for assisting store customers is disclosed. The ‘helping-cart’ is mobile, and carries hardware for dispensing useful information such as product location inside store, detailed product information, etc. The ‘helping-cart’ could also be used to establish a communication link between a customer and a store attendant. Since such a ‘helping-cart’ with the hardware is a valuable asset, there would be attempts to smuggle the ‘helping-cart’ out of the store, especially because it is mobile. An independent data center may provide product information to stores. Various means to deter such potential attempts are presented.

### TECHNICAL FIELD

This invention relates to a retail business.

### BACKGROUND ART

As the retail business becomes more competitive, it is important to enhance the customer services. Some stores use computers or televisions to promote or describe some products. But these services are limited to particular products located near the computers or televisions.

### SUMMARY OF THE INVENTION

Accordingly, it is the objective of the patent application to devise a means to provide a wider range of information on products being sold in a retail store in a more flexible way.

It is an accompanying objective of the patent application to devise a means to enhance the communication between customers and store attendants.

It is another accompanying objective of the present invention to enhance the personal attention to the customers.

It is another accompanying objective of the present invention to reduce the manning level in a store by making the customer service more automated and hardware oriented.

It is another accompanying objective of the present invention to achieve these objectives without a concern of the hardware being stolen by customers.

These objectives are achieved by mounting various information-carrying hardware and communication hardware on a ‘helping-cart’ that is exceedingly tall.

It is desirable to embed sensors and tags to make it difficult to smuggle out the ‘helping-cart’ from the retail store.

It is preferred to have the communication hardware to receive the information from a remote central data bank, possibly through an internet link.

Various means and methods will be described.

### BRIEF DESCRIPTION OF DRAWINGS

FIG. 1 illustrates the invented ‘helping-carts’ in a retail store in a highly schematic fashion.

FIG. 2 shows an example of the preferred embodiment of the ‘helping-cart’ in a highly schematic fashion.

FIG. 3 shows a ‘helping-cart’ with a space to carry shopping items.

FIG. 4 depicts one scenario in which the product information for the ‘helping-carts’ is originated from a remote data center.

### DETAILED DESCRIPTION

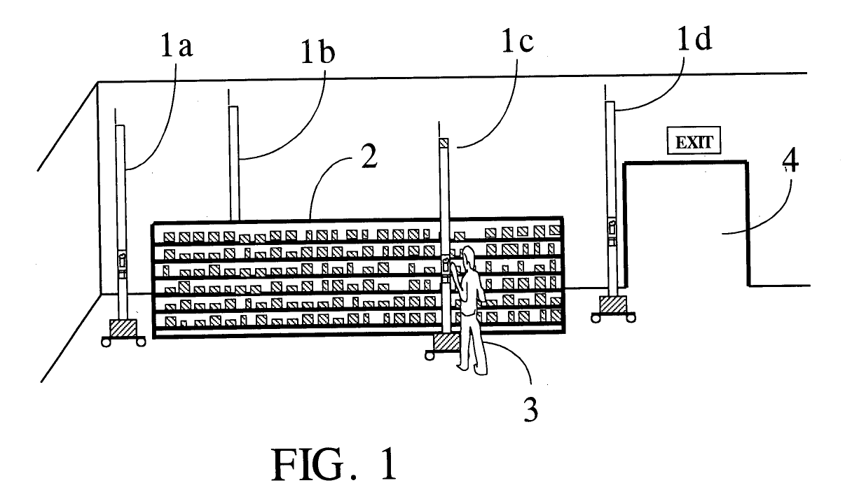

FIG. 1 shows a retail store in a highly schematic fashion.

Shown in FIG. 1 are a few of the ‘helping-carts’, 1a, 1b, 1c, and 1d that are the subject of this invention disclosure.

As indicated in FIG. 1, the ‘helping-carts’, 1a, 1b, 1c, and 1d are quite unusually tall.

The ‘helping-carts’ are preferably taller than the shelf 2b.

The height makes it difficult to smuggle them out since they are quite visible.

Also, if they are tall enough, it would be impossible to load into an ordinary passenger car.

Of course, another purpose of making the ‘helping-carts’ so tall is to be able to spot them easily in a store: customers cannot use them if they cannot see them easily from any place and angle inside the store.

The ‘helping-carts’ are preferably are taller than the clearance of the exit 4: it cannot go though the exit 4 in the upright position if the height exceed the door clearance.

If the ‘helping-cart’ is tall enough, it can pass though the exit 4 only when the ‘helping-cart’ is tilted. Accordingly, it would be desirable to embed sensors that set off an alarm when the ‘helping-cart’ is tilted.

It would be also helpful to embed electronic tags inside the ‘helping-cart’, 1a, 1b, 1c, and 1d if the exit 4 is equipped with an alarm gate to detect such tags.

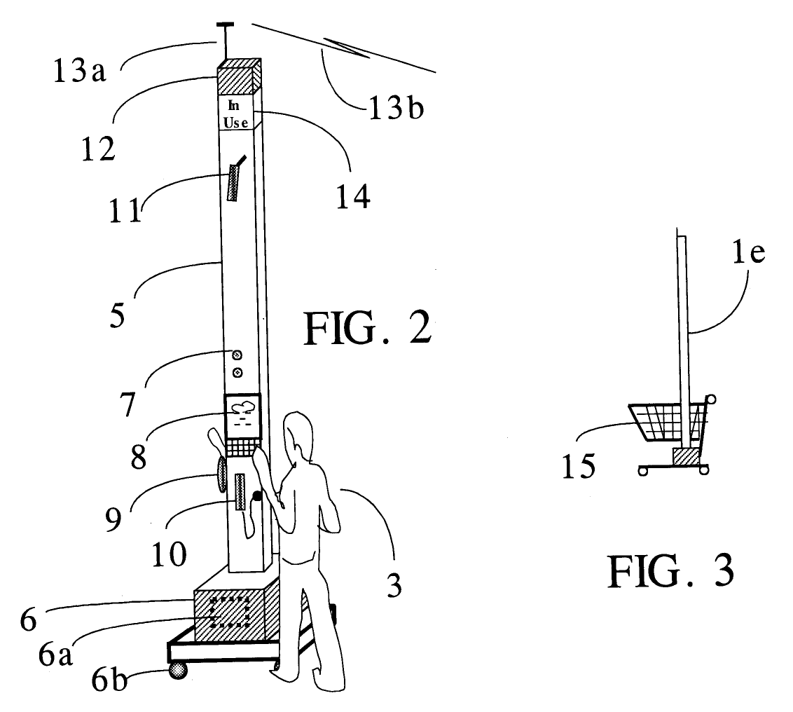

FIG. 2 depicts an example of possible embodiments of the present invention.

The main body 5 of the ‘helping-cart’ is exceedingly tall. Preferably, it is so tall that it cannot be loaded in an ordinary passenger car, as described above.

It is preferably taller than the shelf 2.

Customers 3 can spot a ‘helping-cart’ easily if its height is taller than the shelf 2b as indicated in FIG. 1.

The ‘helping-cart’ has a base 6 that is so designed as to keep the ‘helping-cart’ in the upright position.

The base 6 has wheels 6a or the likes in order to make the ‘helping-cart’ transportable within the store. This mobility is the key to enhancing the customer service, and thus is an essential element of the present invention.

The ‘helping-carts’, 1a, 1b, 1c, and 1d, have some built-in hardware for helping customers, such as the location of a certain product inside the store, detailed information on products on a shelf 2, and even possibly information related to the process of purchasing of a product.

As an example, the ‘helping-cart’, 1a, 1b, 1c, and 1d, could have:
a pushbutton 7 that are used to call a store employee for help;
a computer 8 that can dispense various information, such as product location inside store, product information, and the likes, either on a specific product and on the specific request from a customer 3, or, automatically, that is, on a product when the ‘helper-cart’ passes near the product;
a CD or the like carrying memory for items, preferably according to barcodes;
a barcode scanner or the like 9 for identifying a product of interest and extracting the information associated with the barcode or the like;
a telephone or the like 10 for talking to a store employee;
a video camera 11 through which a store employee can see the general area around the ‘helping-cart’, 1a, 1b, 1c, or 1d, especially the product that the customer 3 is interested in: the customer can show the product in question through the camera 11 to the employee at a remote location inside or even outside the store; the camera could be used to watch over a customer if shop-lifting is suspected, even though such a use is not a primary objective of the present invention;
a light 12 that is turned on when the customer 3 wants the attention of a store employee;
an antenna 13a that transmits signals 13b between the ‘helping-cart’ and a communication gear attended by a store employee at a remote location inside or even outside the store.

The status panel 14 may be added to indicate the status of the ‘helping-cart’, that is, whether the ‘helping-cart’ is being used, or idling and available. It is not good if a customer walks some distance to reach a ‘helping-cart’ only to find that someone is using it. Again, the extreme height would be advantageous even from this viewpoint.

When some or all of such hardware listed above are installed on a ‘helping-cart’, the ‘helping-cart’ becomes an attractive asset, becoming a target for theft. That is, some people would consider smuggling it out of the store, in a similar fashion of removing a shopping cart out of the store premises: the ‘helping-cart’ has hardware in it that are more useful, and possibly more expensive, than a shopping cart.

Deterring thefts is an essential element in the present invention. Without an effective means to deter thefts, ‘helping-carts’ could not be fielded in any store.

As described above, the height would be helpful in deterring thefts: it is quite visible and noticeable, even across the height of the shelves.

However, some additional features would be desirable.

One measure is a ‘tilt-sensor’ that would set off an alarm, either silent or loud, when the ‘helping-cart’ is tilted. Since tilting would be necessary to pass the ‘helping-cart’ through a store exit door, such a sensor would be quite effective in preventing thefts.

Even loading a smuggled-out ‘helping-cart’ on a car or pickup truck would result in an alarm.

An electronic tag could be incorporated if the store exit 4 is equipped with a gate for setting an alarm when such an electronic tag is passing through the gate.

In order to operate some or all of the hardware described above, an electrical power source is needed.

The most convenient power source would be a battery, preferably a rechargeable one. Since such a battery is large and heavy, it would be preferable to store it in the base area 6b. This will make the ‘helping-cart’, 1a, 1b, 1c, and 1d, more stable as desired.

FIG. 3 shows a ‘helping-cart’ 1e coupled with a shopping basket 14 for carrying merchandizes. The ‘helping-cart’ 1e and the shopping basket 14 may be inseparable or separable depending on the store need.

As for the preparation of the product data for the ‘helping-carts’, each store, or its headquarter if the store belongs to a chain, can prepare the information on the products on the shelves in the store, and updates the data.

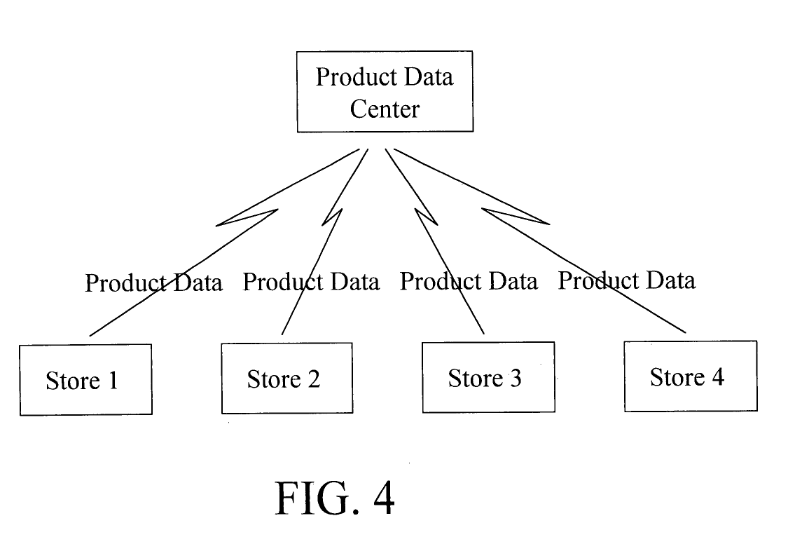

An alternative approach is to receive the information from an independent remote data center, either by a conventional communication link or an internet link (See FIG. 4).

A wireless internet link may be used to communicate the data.

It may be economical to use a wired internet link between the remote data center and a communication center of the store, and then use a wireless communication means between the communication center of the store and each ‘helping-cart’ inside store.

As described above, all the product information could be identified by the universal barcode so that a same data for a product can be used by all the stores that carry that particular product.

In this business scenario, the independent data center may get the product data and information from manufacturers and then distribute the data and information to the stores. In this case, stores do not have to prepare the data and information individually. This will save enormous time and effort that would be resulted when each store prepares the data and information for its own use only.

Some of the teachings described in this patent application may be claimed in a separate patent application to be filed in a later date.

Obviously many modifications and variations of the present invention are possible in light of the above teachings. It is therefore to be understood that, within the scope of the appended claims, the invention may be practiced otherwise than as specifically described.

1. A ‘helping-cart’ (1c) for assisting a store customer (3) comprising a body (5), a base (6), transportation means (6a), and some information hardware; wherein the body (5) is so high as to make it difficult to smuggle the ‘helping-cart’ (1c) out of the store; and the base (6) is designed so as to maintain the ‘helping-cart’ (1c) in the upright position in a stable manner; whereby a customer (3) can push the ‘helping-cart’ around inside the store as needed to find the location of a certain product or obtain a detailed information of a certain product, yet is discouraged from smuggling the ‘helping-cart’ (1c) out of the store.

2. The invention according to claim 1, wherein the height of the ‘helping-cart’ (1c) is greater than the clearance of the store exit (4).

3. The invention according to claim 1, wherein the height of the ‘helping-cart’ (1c) is greater than the cargo space of ordinary automobiles.

4. The invention according to claim 1, wherein a sensor is installed inside the ‘helping-cart’ (1c) so as to detect a tilt of the ‘helping-cart’ (1c), whereby a smuggling of the ‘helping-cart’ (1c) out of the store by tilting the ‘helping-cart’ (1c) is not possible.

5. The invention according to claim 1, wherein an electronic tag is installed inside the ‘helping-cart’ (1c) so as to alarm any attempt to pass the ‘helping-cart’ (1c) through the exit (4) that is equipped with a gate for detecting such electronic tag.

6. The invention according to claim 1, wherein a battery is installed in the ‘helping-cart’ (1c).

7. The invention according to claim 6, wherein the battery is rechargeable.

8. The invention according to claim 6, wherein the battery is stored in the base area (6b).

9. The invention according to claim 1, wherein the information hardware includes pushbuttons (7) that are used to call a store employee for help.

10. The invention according to claim 1, wherein the information hardware includes a computer (8) for dispensing information such as product location inside store, ‘product information’, or the likes.

11. The invention according to claim 10, wherein the ‘product information’ is stored according to the barcode of each product so as to ensure the universality across stores and territories throughout the world.

12. The invention according to claim 10, wherein a certain information is dispensed upon the specific request from the customer (3).

13. The invention according to claim 10, wherein a certain information is dispensed automatically on a product when the ‘helper-cart’ (1c) is near the product.

14. The invention according to claim 1, wherein the information hardware includes a barcode scanner or the like 9 for identifying a product that the customer (3) is interested in.

15. The invention according to claim 1, wherein the information hardware includes a telephone or the like 10 for communicating between the customer (3) and a store employee.

16. The invention according to claim 1, wherein the information hardware includes a video camera (11) through which a store employee can see the general area around the ‘helping-cart’ (1c).

17. The invention according to claim 1, wherein the information hardware includes a light (12) that can be turned on when the customer (3) wants the attention from a store employee.

18. The invention according to claim 1, wherein the information hardware includes an antenna (13a).

19. The invention according to claim 1, wherein the information hardware includes the status of the ‘helping-cart’ (1C) to indicate whether the ‘helping-cart’ 1c is being used or idling and available.

20. The invention according to claim 1, wherein the information received by the information hardware is originated from a remote data center outside the store.

21. The invention according to claim 20, wherein the information is received utilizing an internet link in part.

22. The invention according to claim 21, wherein the information is received utilizing a wireless communication link in part.

23. A ‘helping-cart’ (1c) for assisting a store customer (3) comprising a body (5), a base (6), transportation means (6a), some information hardware, and a storage hardware (14); wherein the body (5) is so high as to make it difficult to smuggle the ‘helping-cart’ (1c) out of the store; and the base (6) is designed so as to maintain the ‘helping-cart’ (1c) in the upright position in a stable manner, and the storage hardware (14) is for storing merchandizes to be purchased by the store customer (3); whereby a customer (3) can push the ‘helping-cart’ around inside the store as needed to find the location of a certain product or obtain a detailed information of a certain product, yet is discouraged from smuggling the ‘helping-cart’ (1c) out of the store.

24. An invention according to claim 23, wherein the storage hardware (14) is separable from the rest of the ‘helping-cart’ embodiment.
